(19) United States
(12) Patent Application Publication
(10) Pub. No.: US 2013/0325721 A1
(43) Pub. Date: Dec. 5, 2013

(54) Data Processing

(71) Applicant: Alibaba Group Holding Limited, Grand Cayman (KY)

(72) Inventors: Tao Ghong, Hangzhou (CN); Chuan Yang, Hangzhou (CN); Wei Zhang, Hangzhou (CN); Ghuangping Ren, Hangzhou (CN); Haixiang Pan, Hangzhou (CN)

(73) Assignee: Alibaba Group Holding Limited, Grand Cayman (KY)

(21) Appl. No.: 13/904,999

(22) Filed: May 29, 2013

(30) Foreign Application Priority Data
May 30, 2012 (CN) 201210174215.6

(51) Int. Cl. G06Q 20/32

(52) U.S. Cl. CPC G06Q 20/322
USPC 705/44

(57) ABSTRACT

A first data processing request initiated by a first communication terminal is received. The first data processing request includes second communication terminal direction information. A communication code of the second communication terminal is obtained according to the second communication terminal direction information. A request for processing data is sent to the second communication terminal according to the communication code of the second communication terminal A second data processing request initiated by the second communication terminal according to the request for processing data is received and a data processing platform is informed to process data. The present techniques triggers the request for processing data of the server through the first data processing request of the first communication terminal and prompts the second communication terminal to send the second data processing request, thereby forming a reliable online payment on delivery (POD).

### CROSS REFERENCE TO RELATED PATENT APPLICATIONS

This application claims foreign priority to Chinese Patent Application No. 201210174215.6 filed on May 30, 2012, entitled “Data Processing Method, Communication Client, Server, and System,” which is hereby incorporated by reference in its entirety.

### TECHNICAL FIELD

The present disclosure relates to the field of communication technology, and more specifically, to a data processing method, communication client, server, and system.

### BACKGROUND

With the development of mobile terminals, mobile networks, and wireless network, e-commerce has changed from traditional wired shopping to wireless shopping. That is, a user previously logged into a fixed terminal and conducted shopping through a wired network. Now the user may log into a portable device and conduct shopping through a wireless network. For example, the user may log into a mobile terminal of a shopping website to conduct shopping at his/her cell phone. Alternatively, the user may log into a client terminal of the shopping website through a smart device such as an iPad™ to conduct shopping via the wireless network.

While wired or wireless shopping is popular, payment has become a challenge, especially pay on delivery (POD.). Currently, the POD usually takes a form of cash payment at the delivery. However, such payment mainly relies on a human. As too many manual factors are involved, it is not a reliable technical scheme.

There is another POD technical scheme based on a hand-held point of sale (POS) terminal. A logistics carrier delivers a product with the POS terminal. After a buyer inspects the product, the buyer slides his/her card (such as a credit card or a debit card) at the POS terminal to complete the payment. This technical scheme, however, does not technically connect a logistics terminal with a transaction system and a buyer's terminal to implement the POD. In addition, this technical scheme has low security and the buyer is easily subjected to fraud or the product is delivered to a wrong recipient. Thus, the conventional technical scheme has low reliability and low efficiency in paying a product provider.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to apparatus(s), system(s), method(s) and/or computer-readable instructions as permitted by the context above and throughout the present disclosure.

The present disclosure provides a data processing method, communication client, server, and system to implement a connection among a logistics terminal, a transaction system, and a buyer's terminal. Thus, an online electronic POD network is implemented and a highly reliable mobile payment is realized.

The present disclosure provides an example data processing method. A first data processing request initiated by a first communication terminal is received. The first data processing request includes second communication terminal direction information. A communication code of the second communication terminal is obtained according to the second communication terminal direction information. A request for processing data is sent to the second communication terminal according to the communication code of the second communication terminal. A second data processing request initiated by the second communication terminal according to the request for processing data is received and a data processing platform is informed to process data.

The present disclosure provides another example data processing method. A first data processing request is sent to a server. The first data processing request includes second communication terminal direction information of a second communication terminal. A responding message from the server that a data processing platform successfully processes data is received. The server may perform the following operations.

A communication code of the second communication terminal is obtained according to the second communication terminal direction information. A request for processing data of an order directed by the second communication terminal direction information is sent to the second communication terminal according to the communication code of the second communication terminal. A second data processing request initiated by the second communication terminal according to the request for processing data is received and the data processing platform is informed to process data.

The present disclosure also provides another example data processing method. After a server receives a first data processing request of a first communication terminal, a request for processing data is sent according to second communication terminal direction information. A second data processing request according to the request for processing data is sent to the server. A responding message sent by the server that a data processing platform successfully processes data is received.

The present disclosure provides an example server. The server may include a receiving unit, an obtaining unit, and a sending unit. The receiving unit receives a first data processing request initiated by a first communication terminal. The first data processing request includes second communication terminal direction information. The obtaining unit obtains a communication code of the second communication terminal according to the second communication terminal direction information. The sending unit sends a request for processing data of an order directed by the second communication terminal direction information according to the communication code.

The receiving unit may further receive a second data processing request initiated by the second communication terminal according to the request for processing data to inform a data processing platform to process data.

The present disclosure also provides an example communication terminal. The communication terminal may include a sending module and a receiving module.

The sending module sends a first data processing request to a server. The first data processing request includes second communication terminal direction information of a second communication terminal. The receiving module receives a responding message from the server that a data processing platform successfully processes data. The server may perform the following operations.

A communication code of the second communication terminal is obtained according to the second communication terminal direction information. A request for processing data of an order directed by the second communication terminal direction information is sent to the second communication terminal according to the communication code of the second communication terminal. A second data processing request initiated by the second communication terminal according to the request for processing data is received and the data processing platform is informed to process data.

The present disclosure also provides another example communication terminal. The communication terminal may include a receiving module and a sending module.

The receiving module receives a request for processing data that is sent by a server after the server receives a first data processing request from a first communication terminal. The first data processing request includes second communication terminal direction information of a second communication terminal. The sending module sends a second data processing request initiated according to the request for processing data to the server.

The receiving module may further receive a responding message from the server that a data processing platform successfully processes data.

The present disclosure also provides an example data processing system. The data processing system may include a first communication terminal, a server, and a second communication terminal.

The first communication terminal sends a first data processing request to the server. The first data processing request includes second communication terminal direction information of the second communication terminal. The first communication terminal also receives a responding message from the server that a data processing platform successfully processes data.

The server receives the first data processing request initiated by the first communication terminal The first data processing request includes second communication terminal direction information. The server obtains a communication code of the second communication terminal according to the second communication terminal direction information, sends a request for processing data to the second communication terminal according to the communication code, and receives a second data processing request initiated by the second communication terminal according to the request for processing data to inform the data processing platform to process data.

The second communication terminal receives the request for processing data of an order directed by the second communication terminal direction information, which is sent by the server after the server receives the first data processing request of the first communication terminal. The second communication terminal sends a second data processing request to the server according to the request for processing data, and receives the responding message sent by the server that the data processing platform successfully processes data.

Therefore, the present techniques use the first data processing request of the first communication terminal of a first user, such as a delivery carrier, to trigger the request for processing data of the server, and prompt the second communication terminal of a second user such as a buyer to initiate the second data processing request to implement a reliable online POD network. Thus, an electronic POD is realized among the carrier, the buyer, and a shopping website.

### BRIEF DESCRIPTION OF THE DRAWINGS

To better illustrate embodiments of the present disclosure, the following is a brief introduction of the FIGs to be used in the description of the embodiments. It is apparent that the following FIGs only relate to some embodiments of the present disclosure. A person of ordinary skill in the art can obtain other FIGs according to the FIGs in the present disclosure without creative efforts.

FIG. 1 illustrates a diagram of an example system for processing data according to the present disclosure.

FIG. 2 illustrates a flowchart of an example method for processing data according to the present disclosure.

FIG. 3 illustrates a flowchart of another example method for processing data according to the present disclosure.

FIG. 4 illustrates a flowchart of another example method for processing data according to the present disclosure.

FIG. 5 illustrates a diagram of an example method for verifying identity of the first communication terminal according to the present disclosure.

### DETAILED DESCRIPTION

The example embodiments of the present invention and the features in the embodiments may be mutually combined or referenced to each other in case that they are not in conflict with each other. The following descriptions are described by reference to the FIGs and some example embodiments.

In an example embodiment, a first communication terminal sends a first data processing request to a server which triggers the server to send a request for processing data to a second communication terminal. This triggers the second communication terminal to send a second data processing request to the server. Thus, a reliable online POD network is implemented and a secure POD for online shopping is realized.

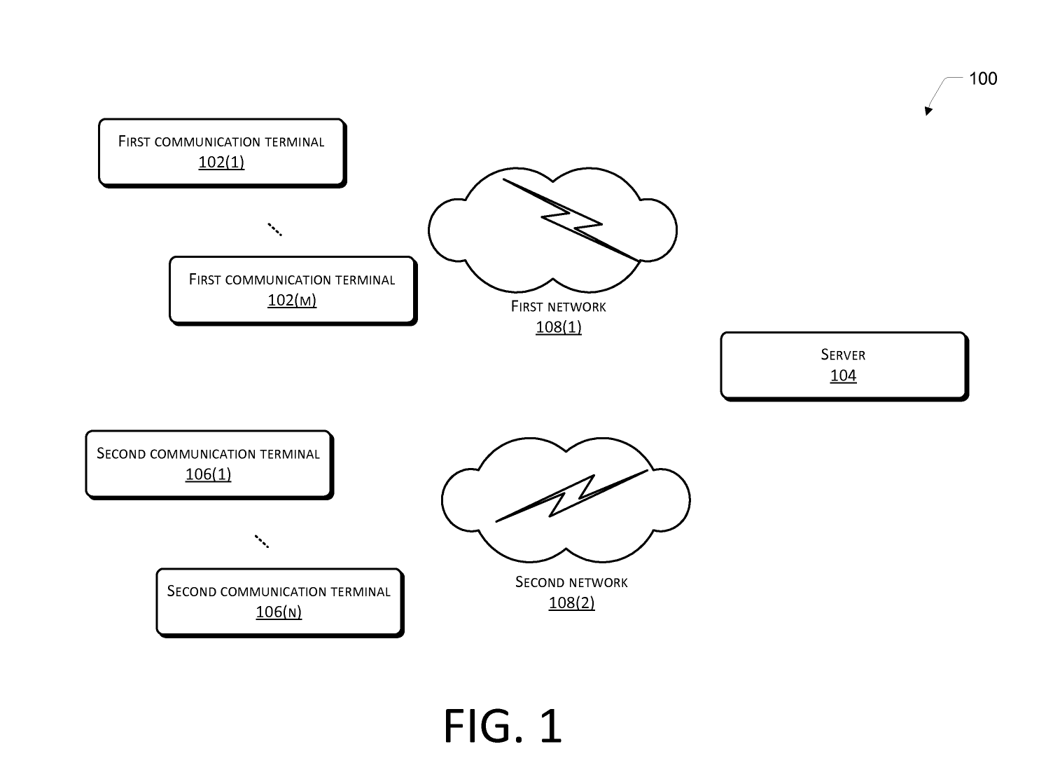

FIG. 1 illustrates a diagram of an example system 100 to implement an example data processing method. In the example of FIG. 1, the system 100 may include a first communication terminal 102, a server 104, and a second communication terminal 106. There might be multiple first communication terminals and second communication terminals. In the example of FIG. 1, there are first communication terminals 102(1), . . . , 102(m), where m may be any integer, and second communication terminals 106(1), . . . , 106(n), where n may be any integer. For instance, the first communication terminal 102(1) may be a communication terminal that is hand-held by a first user such as a logistics carrier. The second communication terminal 106(1) may be a hand-held by a second user such as a buyer of a product. The first communication terminals 102 may communicate with the server 104 through a first network 108(1) and the second communication terminals 106 may communicate with the server 104 through a second network 108(2). The first network 108(1) and the second network 108(2) may be the same network such as the Internet.

The system 100 implements an efficient and highly reliable online electronic POD. The logistics carrier delivers the product purchased by the buyer to the buyer and sends a first data processing request to the server 104 through the first communication terminal such as the first communication terminal 102(1). After receiving the first data processing request, the server 104, according to a second communication terminal direction information included in the first data processing request, such as an order number, searches a database to find a communication code of a communication terminal, such as the second communication terminal 106(1), of the buyer corresponding to the second communication terminal direction information, such as the order information. For example, the communication code may be a phone number, such as a cell phone number, a user name of an instant communication application, or any other payment information such as a third party payment account, bank account, etc.

The server 104 sends a request for processing data to a second communication terminal, such as the second communication terminal 106(1), that corresponds to the communication code. The request for processing data includes a request that a payment is to be paid. The request for processing data may be carried by a message such as a short text message or a short message including a link for processing data sent through a text message gateway, or a message including the link for processing data through a wireless network or a mobile network.

After the second communication terminal 106(1) of the buyer receives the request for processing data, it initiates a second data processing request to the sever 104 by various methods such as replying the message sent by the server or sending a page request. The server 104 informs a data processing platform to process the data such as making payment.

The first communication terminal 102(1) and the second communication terminal 106(1) used by the carrier and the buyer may refer to any kind of mobile terminal with wireless communication functionalities such as various mobile communication devices including a cell phone, a personal digital assistant (PDA), a personal communication service (PCS), a wireless phone, or any mobile terminal with wireless communication functionalities that are capable to access shopping websites through the wireless network such as WiFi™ including a laptop with WiFi™ functionalities, a cell phone or a tablet with WiFi™ functionalities such as iPhone™ and iPad™.

For example, at a server of a shopping website, when the buyer buys a certain type of product online, an order is formed and saved in a database of the server. The order may save information such as a name of a logistics company, a carrier shipping number, a product order, information of the purchased product, information of a recipient, address information, and the communication code of a terminal of the recipient such as a cell phone number or a user name of an instant communication application provided by the shopping website to the buyer or payment information such as a third party payment account number, bank account number. The payment information may be saved in a separate data table corresponding to a user name of the buyer and/or cell phone information of the recipient. The user name of the instant communication application may be the user identification (ID) of the buyer at the shopping website. Thus, there is a unique corresponding relationship between the user name of the instant communication application and the order. For instance, the user may have the same user name at the shopping website such as Taobao™ and the instant communication application such as Aliwangwang™.

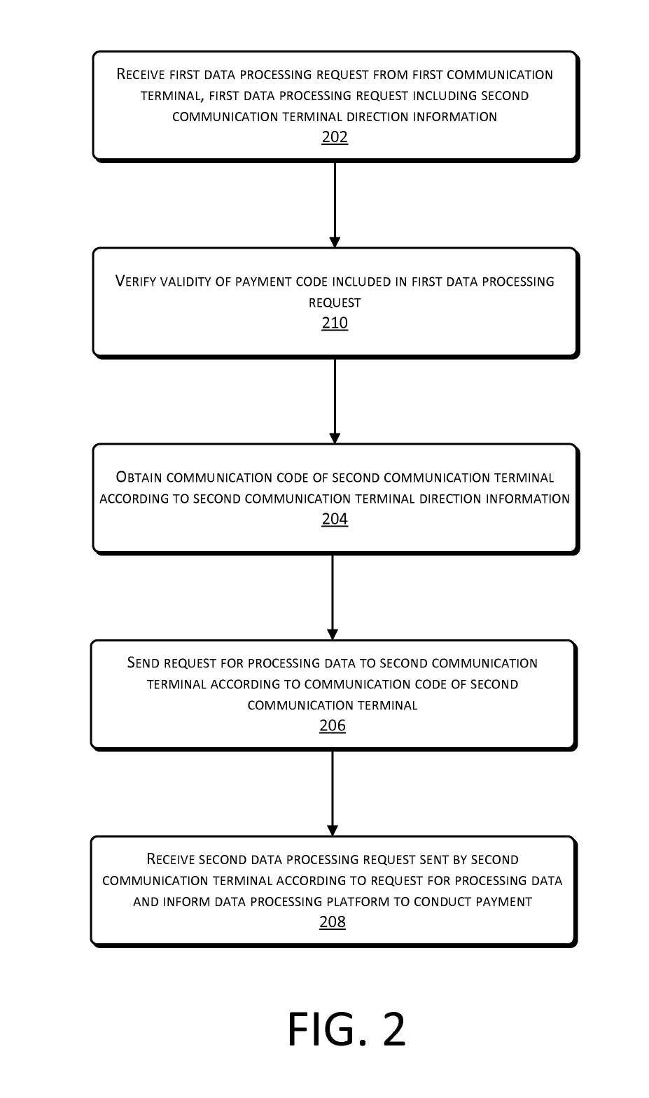

FIG. 2 illustrates a flowchart of an example method for processing data in accordance with the present disclosure. Description of this example embodiment may be also referenced to FIG. 1. In this example embodiment, the executing entity is the server 104. The server 104 may be a data processing server of the shopping website. The server 104 may perform the following operations.

At 202, the first data processing request is received from the first communication terminal such as the first communication terminal 102(1). The first data processing request includes the second communication terminal direction information.

For example, the first communication terminal 102(1) of the carrier may be a PDA. The server 104 receives the first data processing request from the PDA, analyzes the second communication terminal direction information included in the first data processing request such as the order number or the shipping number, or the communication code of the second communication terminal such as the cell phone number or the user name. The second communication terminal direction information is used to search or index the communication code of the second communication terminal. For example, according to the shipping number or the product number included in the second communication terminal direction information, the database may be searched to obtain the communication code of the second communication terminal. Alternatively, the second communication terminal direction information may directly indicate the communication code of the second communication terminal such as the cell phone number or the user name.

At 204, the communication code of the second communication terminal 106(1) is obtained according to the second communication terminal direction information.

Specifically, the server 104 searches the database to find a corresponding order according to the second communication terminal direction information such as the order number, and finds a corresponding communication code of the buyer of the order from the order such as the cell phone number of the recipient or the user name of the instant communication application.

Alternatively, if the second communication terminal direction information includes the cell phone number of the second communication terminal 106(1) of the buyer, the server 104 analyzes the first data processing request to obtain the cell phone number. The cell phone number is the communication code of the second communication terminal 106(1). Alternatively, the communication code, which is the user name, is obtained from the database according to the cell phone number.

In an event that the second communication terminal direction information includes the user name of the second communication terminal 106(1) of the buyer, the server 104 analyzes the first data processing request to obtain the user name. The user name is the communication code of the second communication terminal 106(1). Alternatively, the communication code, which is the cell phone number, is obtained from the database according to the user name.

At 206, a request for processing data is sent to the second communication terminal 106(1) according to the communication code of the second communication terminal 106(1).

For example, when the communication code is the cell phone number, the server 104 sends the request for processing data, which may be a short message, to the second communication terminal 106(1) corresponding to the cell phone number through a text message gateway of a telecommunication service provider. The short message, for instance, may be “a purchase amount $100 for order number XX at AA shopping website. Reply Y for payment; otherwise reply N for non-payment.” The request for processing data may also be a short message including a link for data processing. The short message, for instance, may be “a purchase amount $100 for order number XX at AA shopping website. Please click the following payment link https://payment.xx.com for payment.” As the communication code is searched according to the second communication terminal direction information such as the order number obtained at 202, the request for processing data may include information other than payment amount, such as order information.

Alternatively, when the communication code is the cell phone number, the server 104 sends the request for processing data, which may be a short message, to the second communication terminal 106(1) corresponding to the cell phone number through a text message gateway of a telecommunication service provider. The short message, for instance, may be “a purchase amount $100 at AA shopping website. Reply Y for payment; otherwise reply N for non-payment.” The request for processing data may also be a message such as a short message including a link for data processing. The short message, for instance, may be “a purchase amount $100 at AA shopping website. Please click the following payment link https://payment.xx.com for payment.” The communication code is directly obtained according to the second communication terminal direction information such as the cell phone number. Thus, the request for processing data may only include payment amount information. Although the order number is not included, as the payment is POD, the second communication terminal 106(1) of the buyer may also confirm whether an amount to be paid is an amount of the delivered product according to the received request for processing data.

Alternatively, when the communication code is the user name, the serve 104 sends a message such as a pop-up message to a client of the instant communication application with the user name. The pop-up message is the request for processing data. For example, the pop-up message may be a message including the link for processing data such as “a purchase amount $100 at AA shopping website. Please click the following payment link https://payment.xx.com for payment.” As the communication code is obtained according to the second communication terminal direction information such as the order number at 202, the request for processing data may include not only payment amount information but also order number information.

At 208, a second data processing request initiated by the second communication terminal 106(1) according to the request for processing data is received, and a data processing platform is informed to conduct payment processing.

For example, when the second communication terminal 106(1) of the buyer receives the request for processing data, which is the short text message that does not include the order number, the buyer replies to the short text message by a text message such as “yes” through the second communication terminal 106(1). That is, the buyer replies to the short text message by sending another short text message through the short message gateway. After the server 104 receives the second data processing request initiated by the second communication terminal 106(1) such as a reply short text message, the server 104 obtains the payment information from a data table of the buyer. According to a preset protocol between the server 104 and the data processing platform, the server 104 informs the data processing platform such as a payment system of a bank system corresponding to a bank account or bank card number to deduct the payment amount. After the data processing platform of the bank system successfully deducts the payment amount, it informs the server 104. It is a conventional technique that the data processing platform conducts payment according to the short text message, which is not detailed herein.

Alternatively, when the second communication terminal 106(1) of the buyer receives the request for processing data, which is the short message that does not include the order number and includes the link for data processing, the buyer clicks the links for data processing through the second communication terminal 106(1). That is, the buyer sends the second data processing request through a page request of data processing via the mobile Internet or the wireless Internet. An accessing website provides a payment page such as a payment page of the bank system or a payment page of Alipay™. The server 104, according to the payment information recorded in the data table of the buyer, informs the data processing platform such as a third party data processing platform Ailpay™ to conduct data processing such as deducting the payment amount or conducting the data processing through the bank system and then informs the server 104. It is a conventional technique for the third party data processing platform or the bank system to conduct payment, which is not detailed herein.

Alternatively, when the second communication terminal 106(1) of the buyer receives the request for processing data which is the pop up message that does not include the order number and includes the link for data processing, the buyer clicks the links for data processing through the second communication terminal 106(1). That is, the buyer sends the second data processing request through a page request of data processing via the mobile Internet or the wireless Internet. An accessing website provides a payment page such as a payment page of the bank system or a payment page of Alipay™. The server 104, according to the payment information recorded in the data table of the buyer, informs the data processing platform such as a third party data processing platform Ailpay™ to conduct data processing such as deducting the payment amount or conducting the data processing through the bank system and then informs the server 104. It is a conventional technique for the third party data processing platform or the bank system to conduct payment, which is not detailed herein.

If the short text message including pure text, the short message including the link for data processing, or the pop-up message including the link for data processing also includes the order number, the server 104 obtains the payment information from order details recorded in the database according to the order number. It is not necessary to obtain the payment information from an independently saved data table.

The present techniques use the first communication terminal of the carrier to initiate the first data processing request. Through the second communication terminal direction information included in the first data processing request, the communication code of the second communication terminal for POD is obtained to initiate the request for processing data to the second communication terminal of the buyer corresponding to the communication code. The buyer initiates the second data processing request according to the request for processing data to request the server to conduct data processing to the purchase transaction. Thus, a confirmed POD is formed and a reliable POD is realized. It is convenient for the logistics company to save the shipping number corresponding to each transaction and to settle with the product supplier of the shopping website.

As shown in FIG. 2, to avoid fraud, for example, the communication terminal of the carrier, such as the first communication terminal 102(1) which may be a PDA, may need to be verified for its identity before it is allowed to send the first data processing request to the server 104 and request the server 104 to send the request for processing data to the second communication terminal 106(1). In one example embodiment, operations may include an additional step between 202 and 204, i.e. 210, which verifies a validity of a payment code included in the first data processing request.

In addition, for example, before 202, the operations may include the following.

At 11, a log-in request from the first communication terminal 102(1) is received. The log-in request includes a security code of the first communication terminal 102(1).

At 12, a usability of the security code is verified.

At 13, after the security code is verified to be usable, the payment code of the first communication terminal 102(1) is generated and sent to the first communication terminal 102(1) for storage.

The first communication terminal 102(1) may send the first data processing request to the server 104 through a GPRS network or WiFi network. However, the carrier, as a third party to the transaction, would need to directly face the customer. Thus, it is required to timely monitor the identification validity of the first communication terminal 102(1), which indirectly monitors an identity of the carrier to avoid fraud for POD. For example, the logistics company and the server of the shopping website may exchange a usable or non-usable usable status of the communication terminal of the carrier of the logistics company and save it in a database of the server. Thus, the database of the server may store communication terminals of each logistics company and a corresponding table of their usable statuses. The corresponding table may include a serial number of hardware and its status. Alternatively, the corresponding table may include a code for unique identification of each first communication terminal and its status and some other information such as signature information to generate the payment code. The corresponding table may be stored in the database of the server of the shopping website. Alternatively, the corresponding table may be stored and maintained at a database of a server of a corresponding logistics company. A transaction server of the shopping website, after receiving the log-in request of the first communication terminal, forwards the request to the server of the logistics company for identity verification.

For example, the carrier logs into the client terminal of the first communication terminal and sends the log-in request. The server receives the log-in request, parses the security code of the first communication terminal such as a hardware serial number of the communication terminal, and searches the database to find the usability of the device corresponding to the security code. After the first communication terminal is verified to be usable, the server sends the payment code to the first communication terminal such as the PDA. The security code of the first communication terminal may be a code for identification generated based the hardware serial number of the communication terminal.

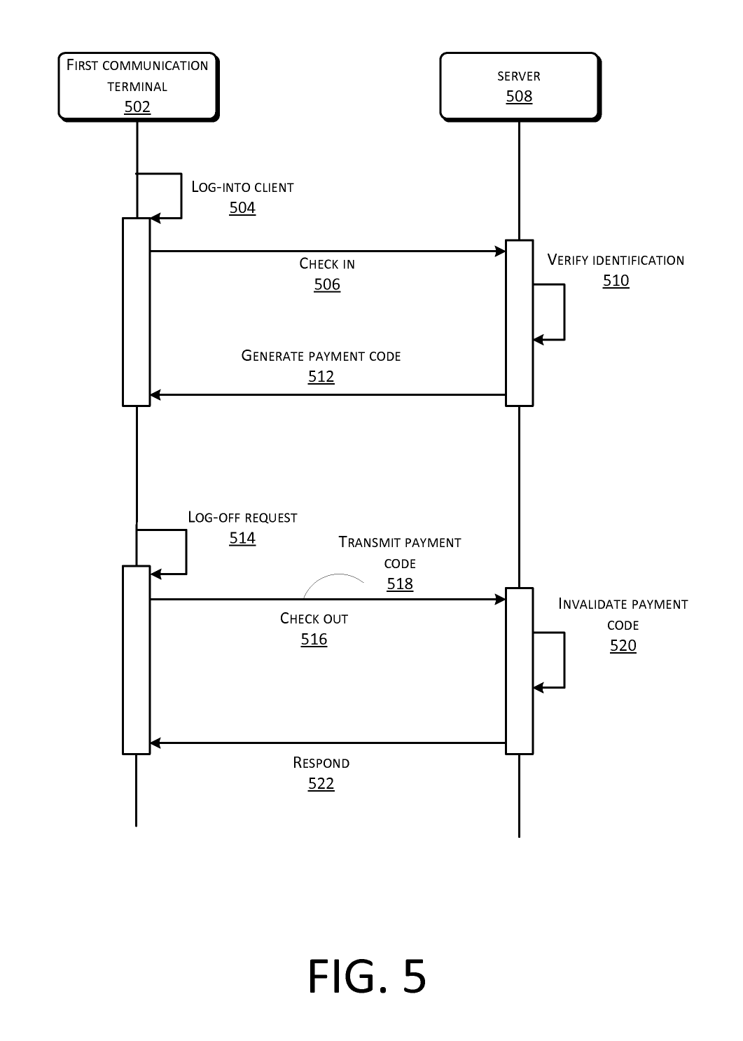

FIG. 5 illustrates a diagram of an example method for verifying the identification of the first communication terminal 502 according to the present disclosure. When the carrier logs in 504 the first communication terminal 502, a client at the first communication terminal 502 initiates a log-in request to check in 506 that may include a request for a dynamic payment code from a server 508. A prerequisite for the server 508 to assign the payment code is that a status of the first communication terminal 502 is valid. The server 508 conducts identity verification 510 of the first communication terminal 502. The server 508 generates the payment code 512. For example, the server 508 may use the hardware serial number to search the usable or unstable status of the first communication terminal 502 for verification and send the payment code to the first communication terminal 502. After obtaining the payment code, the first communication terminal 502 saves the payment code into its memory and uses the payment code as an entry parameter in each of the following first data processing requests. In other words, the first data processing request at 202 may include the payment code.

After the safety of the first communication terminal 502 of the carrier is verified, the carrier sends a log-off request 514 through the first communication terminal 502 to check out 516. The payment code as a parameter is saved in the log-off request. That is, the payment code is transmitted 518 to the server 508. The log-off request informs the server 508 to invalidate the payment code 520 currently held by the first communication terminal 502. The server 508 then responds 522 to the first communication terminal 502. Alternatively, when the carrier logs-off the client at the first communication terminal 502, the first communication terminal may also initiate the log-off request to the server 508 and receives a successful message that the payment code is invalid. For example, the operations may include the following. The log-off request initiated by the first communication terminal is received. The log-off request includes the payment code. The payment code is deleted from a payment code pool.

For example, the payment code may be generated based on the security code of the first communication terminal such as the hardware serial number, a current time, and a signature negotiated between the first communication terminal and the server and encrypted by one or more algorithms. Each dynamic payment code, for example, may have a valid period. After the valid period expires, a new dynamic payment code needs to be applied. In addition, each payment code may be guaranteed unique in at least two dimensions including terminal and time. Thus, a message digest algorithm (MD5) may be used to encrypt the generated dynamic payment code based on the hardware serial number, the current time, and the signature. The string of signature may be agreed between the logistics company and the shopping website when the corresponding table and signature information of the first communication terminal are saved at the database of the server. Before the dynamic payment code is generated, the usable status of the first communication terminal, such as the hardware serial number, is verified. If the status of the hardware serial number is not usable, the first communication terminal may be declined to be assigned the payment code. The server may maintain the payment code pool that is a database that stores the payment code. Each payment code is assigned a valid period, such as 24 hours, when it is saved in the payment code pool. When the valid period expires, such payment code is automatically cleared. Thus, when the first communication terminal initiates the request for processing data, the server obtains the payment code included in the request for processing data and determines whether it is matched to any payment code stored in the payment code pool to complete a verification of the first communication terminal such as the PDA.

The above identification verification technique can indirectly identify the identity of the carrier and thus effectively prevent fraud during POD. The techniques that automatically generate the payment code may ensure that the identification of each first communication terminal is periodically checked, which prevents the payment risk arising from static payment code that may last for a long time. In addition, the logistics company may lose control of the first communication terminal such that the first communication terminal is lost. Based on the present techniques, the user cannot initiate any payment action after the dynamic payment code expires, which increases the security of the payment.

As shown in FIG. 2, after the first communication terminal 102(1) of the carrier obtains the dynamic payment code after the identification verification, the server 104 receives the first data processing request. As the first data processing request includes the payment code, the server 104 may perform the following operations. At 210, the server 104 verifies the validity of the payment code included in the first data processing request. For example, the server 104 determines whether there is a matching payment code in the payment code pool. After the payment code is verified to be valid, the server 104 performs the operations at 204 to obtain the communication code of the second communication terminal 106(1) according to the second communication terminal direction information.

Thus, the techniques that automatically generate the payment code may ensure that the identification of each first communication terminal is periodically checked, which prevents the payment risk arising from static payment code that may last for a long time. In addition, the logistics company may lose control of the first communication terminal such that the first communication terminal is lost. Based on the present techniques, the user cannot initiate any payment action after the dynamic payment code expires, which increases the security of the payment.

In some examples, between the operations at 204 that the communication code of the second communication terminal 106(1) is obtained according to the second communication terminal direction information and the operations at 206 that the request for processing data is sent to the second communication terminal 106(1) based on the communication code, the server 104 may generate security verification information corresponding to the communication code of the second communication terminal 106(1). Thus, the request for processing data at 206 may include the security verification information such as a verification code. The server 104 sends the request for processing data including the verification code to the second communication terminal 106(1). For example, when the request for processing data is in the form of a text message, in addition to those described above, the text message may include the verification code. Thus, the second data processing request initiated by the buyer through the second communication terminal 106(1) also includes the security verification information. For example, when the second data processing request is a reply text message, the reply text message may include the verification code information.

For another example, when the request for processing data is the message including the link for data processing, in addition to those described above, the message may include the verification code. The second data processing request initiated by the buyer through the second communication terminal 106(1) is a page request. When the page request is associated or connected with the payment page of a website, the buyer inputs the verification code to confirm the payment page and inform the data processing platform such as the third party data process platform to conduct data processing such as deducting payment or processing data through a bank system.

Thus, the operations at 208 that the server 104 receives the second data processing request from the second communication terminal 106(1) according to the request for processing data to inform the data processing platform to conduct data processing may include the following.

The server 104 receives the second data processing request from the second communication terminal 106(1). The server 104 verifies the security verification information included in the second data processing request. The server 104 verifies the validity of the security verification information. After the security verification information is verified to be valid, the server 104 informs the data processing platform to conduct data processing.

Thus, after the second communication terminal 106(1) initiates the second data processing request in a form of the reply message, the reply message includes the security verification information such as the verification code. Alternatively, the second communication terminal 106(1) initiates the second data processing request in the form of the page quest, and inputs the verification code information at the payment page to confirm payment when making payment at the payment page. The present techniques prevent malicious attacks from the third party to conduct identification fraud.

After the server 104 sends the notification message to the data processing platform, it receives the responding message from the data processing platform. The server 104 may perform the following operations. The server 104 receives the responding message that the data processing platform successfully processes data and saves a detailed payment order. The detailed payment order includes the second communication terminal direction information of the second communication terminal 106(1) such as the cell phone number or the order payment. The server 104 sends the responding message to the first communication terminal 104(1) and the second communication terminal 106(1).

After the first communication terminal 102(1) and the second communication terminal 106(1) receives the responding message, the carrier of the logistics company may conduct a query according to the responding message. The server 104 may further perform the following operations.

The server 104 receives the query request from the first communication terminal 102(1). The query request includes the second communication terminal direction information of the second communication terminal 106(1). The corresponding detailed payment order is searched according to the second communication direction information of the second communication terminal 106(1).

The above description describes that the server 104 sends the responding message that the data processing platform successfully processes the data to the first communication terminal 102(1). Alternatively, the server 104 is not necessary to send the responding message to the second communication terminal 106(1). The carrier may initiate the inquiry of the payment status to the server 104 and obtain information whether the current payment is successful.

The present techniques trigger the request for processing data from the server 104 through the first data processing request sent by the first communication terminal 102(1) of the carrier and prompt the second communication terminal 106(1) of the buyer to send the second data processing request, thereby forming a secure online POD network. The present techniques use the payment code to verify the identity of the carrier, request the buyer to input the verification code to ensure payment security, and effectively send the payment to the product supplier.

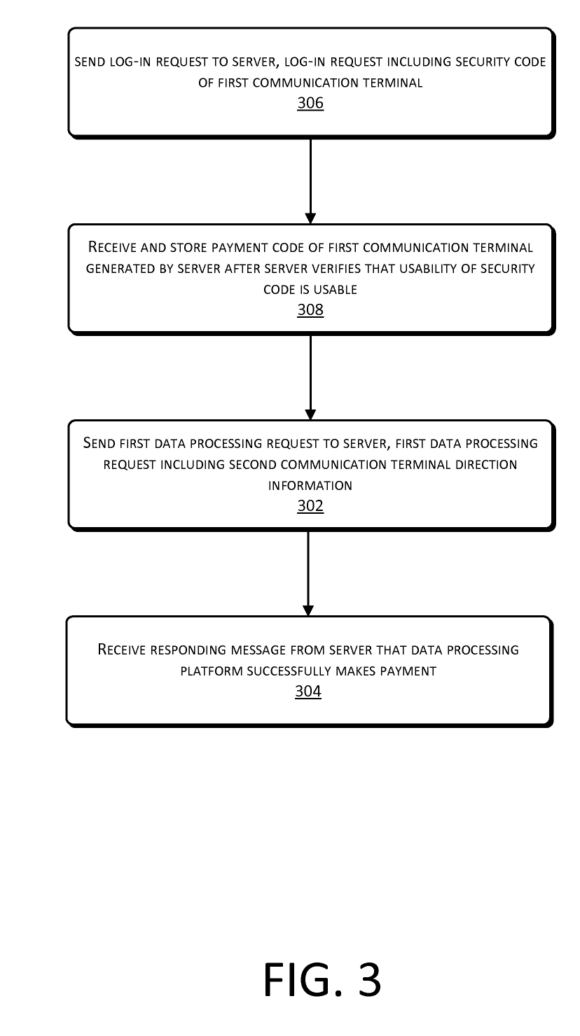

FIG. 3 illustrates a flowchart of an example method for processing data in accordance with the present disclosure. In this example embodiment, a performing entity is the first communication terminal or a handheld communication terminal of the carrier. In this example embodiment, the first communication terminal performs the following operations.

At 302, the first communication terminal sends the first data processing request to the server. The first data processing request includes the second communication direction information of the second communication terminal

For example, the carrier may scan a bar code of a shipping note of a delivered product. A client at the first communication terminal may display contents of the shipping note. The shipping note may record a carrier shipping number, a carrier collect amount, a serial number of the logistics company, an order number of the buyer, a delivery address, a recipient name, a recipient zip code. If the carrier logs into the client at the first communication terminal after identification verification, the first communication terminal also saves an employee number corresponding to a logged-in user name. Alternatively, when the carrier logs into the client at the first communication terminal after the identification verification, the server sends all shipping notes corresponding to the employee number of the carrier at a current day to the first communication terminal Thus, the client at the first communication terminal displays a list of shipping notes. As each communication terminal has its unique hard serial number, such hardware serial number is stored in the storage unit of the communication terminal.

For example, the carrier delivers the product to the buyer and collects payment of the delivery. The carrier clicks the shipping note presented on a display screen of the first communication terminal. For instance, a shipping note page at the client of the first communication terminal may display a payment button. The carrier clicks the payment button and sends the first data processing request. The first data processing request includes the second communication terminal direction information which may be the order number or the shipping number. The second communication terminal direction information may also be the communication code of the second communication terminal such as the cell phone number or the user name. The carrier, after logging into the client at the first communication terminal, may directly input the cell phone number or the user name at the shipping note page, and then send the first data processing request, thereby avoiding delivering the product to a wrong recipient and requesting the wrong recipient for payment.

The first data processing request may include the order number, the shipping number, the cell phone number, the user name, and any other supplemental information such as the carrier collection amount, the serial number of the logistics company, the recipient address, the recipient name, the recipient zip code, and the employee number of the logistics company.

At 304, the first communication terminal receives a responding message from the server that the data processing platform successfully processes data.

After the first data processing request is sent to the server, the server obtains the communication code of the second communication terminal such as the cell phone number according to the second communication terminal direction information included in the first data processing request such as the order number. The sever then, according to the communication code such as the cell phone number, sends the request for processing data of the order directed by the second communication terminal direction information to the second communication terminal and receives the second data processing request initiated by the second communication terminal according to the request for processing data. The server informs the data processing platform to conduct data processing. The detailed operations of the server may refer to the descriptions of the example embodiment as shown in FIG. 2 and are not detailed herein.

After the buyer replies the message or sends the page request, the server conducts the data processing and the client at the first communication terminal of the buyer receives a message from the server that the server has completed the payment. The carrier may conduct a query through the first communication terminal. The query includes the second communication terminal direction information of the second communication terminal to inquire the detailed payment order corresponding to the second communication terminal direction information of the second communication terminal. The carrier may conduct the query through the client at the first communication terminal. For example, after receiving the responding message, the carrier may click a query button display at a page to conduct query. The query includes the shipping number, the order number, or the cell phone number. The server sends the corresponding detailed payment order. The carrier saves the detailed payment order to conduct the following payment. Thus, the electronic payment is realized. It is not necessary to manually collect the payment, thereby efficiently clearing the payment to the product supplier.

Thus, the online POD is triggered by the first data processing request sent by the first communication terminal of the carrier, thereby ensuring the security of the payment.

In some examples, after the product is delivered to the buyer, the first communication terminal may need to pass the usability identification verification and then conduct data processing request. In other words, the server requires the first communication terminal to pass the identification verification before the first communication terminal of the carrier sends the first data processing request. Thus, before operations at 302, the first communication terminal may conduct the following operations in some examples.

At 306, the first communication terminal sends the log-in request to the server. The log-in request includes the security code of the first communication terminal.

For example, the carrier logs into the client at the first communication terminal through a page. For instance, a log-in page may request the user name and password. The carrier inputs the user name and password and initiates the log-in request. As the communication terminal stores the security information such as hardware serial number or a security code, the log-in request may include the security information.

At 308, after the server verifies the usability of the security information or that the security code is usable and generates the payment code of the first communication terminal, the first communication terminal receives the payment code and stores it.

For example, the logistics company and the server of the shopping website may exchange a usable or non-usable status of the communication terminal of the carrier of the logistics company and save it in a database of the server. Thus, the database of the server may store communication terminals of each logistics company and a corresponding table of their usable statuses. The corresponding table may include serial number of hardware and its status. Alternatively, the corresponding table may include a code for unique identification of each first communication terminal and its status. The corresponding table may be stored in the database of the server of the shopping website to determine the usability of the first communication terminal Alternatively, the corresponding table may be stored and maintained at a database of a server of a corresponding logistics company. A transaction server of the shopping website, after receiving the log-in request of the first communication terminal, forwards the request to the server of the logistics company for identity verification.

After the server verifies that the first communication terminal is a usable and valid terminal, the server generates the payment of the first communication terminal and returns it to the first communication terminal. The first communication terminal saves the payment code and uses it as the entry parameter of the first data processing request. In other words, when the first data processing request is initiated at 302, the first data processing request includes the payment code. The server informs the second communication terminal for the following operation of data processing only after the payment code is verified.

After the carrier completes the delivery and logs off the client at the first communication terminal, the first communication terminal sends a log-off request to the server. The log-off request includes the payment code for the sever to clear it from the payment code pool. The payment code is generated and encrypted by the algorithms based on the security code of the first communication terminal, the current time, and the signature between the first communication terminal and the server. In other words, the carrier completes logging-in and logging-off of the carrier assignment through the client at the first communication terminal. Thus, the identification verification of the first communication terminal is conducted, and the identity of the carrier is also identified, thereby effectively preventing fraud during POD. The techniques that automatically generate the payment code may ensure that the identification of each first communication terminal is periodically checked, which prevents the payment risk arising from a static payment code that may last for a long time. In addition, the logistics company may lose control of the first communication terminal such that the first communication terminal is lost. Based on the present techniques, the user cannot initiate any payment action after the dynamic payment code expires, which increases the security of the payment.

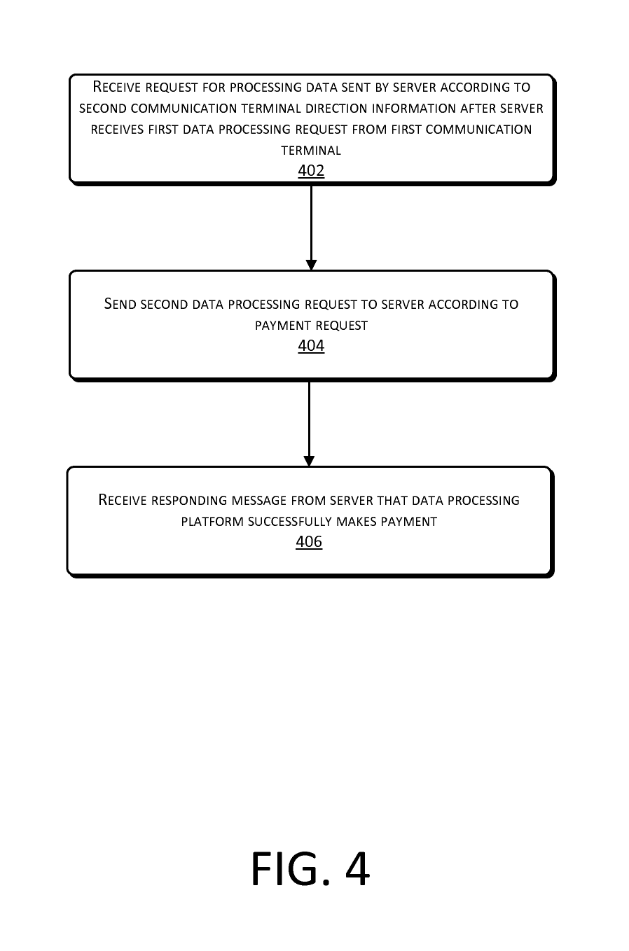

FIG. 4 illustrates a flowchart of another example method for processing data in accordance with the present disclosure. In this example embodiment, the performing entity is the second communication terminal which may be a hand-held communication terminal of the buyer such as a cell phone. In this example embodiment, the second communication terminal may perform the following operations.

At 402, the second communication terminal receives the request for processing data sent by the server according to the second communication terminal direction information after the server receives the first data processing request from the first communication terminal.

For example, after the buyer signs the product delivered by the carrier, the buyer waits for the carrier to send the first data processing request to the server. The second communication terminal direction information may be the order number or the communication code which may be the cell phone number or the user name of the order input by the carrier. When the second communication terminal direction information is the order number, the server searches the communication code of the second communication terminal of the buyer according to the order number, which may be the cell phone number or the user name information. If the communication code of the second communication terminal is the cell phone number, the server, after processing the first data processing request, sends the text message which is the request for processing data. When the request for processing data is in the form of a short message, the short message may be a pure text message or a short message including a link for processing data. If the communication code of the second communication terminal is the user name, the request for processing data may be in the form of a pop-up message sent to the instant communication tool. The pop-up message includes the link for processing data.

At 404, the second communication terminal sends the second data processing request to the server according to the request for processing data.

After the buyer receives the request for processing data such as the pure text message, the buyer replies the message. The reply message may be the text message that includes yes or no text information or the message that includes the security verification information. It ensures the payment security includes the security verification information in the text message.

Alternatively, after the buyer receives the request for processing data such as the message including the link for processing data, the buyer clicks the link for processing data in the message through the second communication terminal and sends the page request through the mobile Internet or the wireless Internet to connect with the payment page, such as the payment page at the payment platform Ailpay™. The page corresponding to the link for processing data may be the payment page of the third party that the buyer saves the payment page after the buyer purchases the product. Alternatively, when the request for processing data received by the buyer is the pop-up message to the instant communication tool, the buyer clicks the link for processing data included in the pop-up message and sends the page request to connect with the payment page, such as the payment page at the payment platform Ailpay™, and triggers the third party data processing platform to conduct payment.

When the sever sends the request for processing data in the form of the pop-message, the server receives the first data processing request and searches the communication code of the second communication terminal of the buyer, which may be the user name of the instant communication tool, based on the second communication terminal direction information included in the first data processing request such as the order number. For example, the instant communication tool may be provided by the shopping website or the account of the shopping website and the account of the instant communication tool are bound to use based on protocol. For instance, the account of the shopping website may be the same as the account of the instant communication tool. When the server checks to find the status of the user name of the account of the instant communication tool is available or online, the server sends the pop-up message to the account of the instant communication tool. Thus, the buyer receives the pop-up message at the second communication terminal to conduct data processing.

At 406, the second communication terminal receives the responding message from the server that the data processing platform successfully processes data.

After the buyer receives the responding message from the server that the data processing is successful, the buyer starts the query through the second communication terminal to inquire the server of the detailed payment order corresponding to the second communication terminal direction information of the second communication terminal The responding message may include various information such as the order number and the payment amount. The query includes the second communication terminal direction information of the second communication terminal

The present techniques implement the electronic POD among the buyer, the carrier, and the shopping website instead of cash transaction. The present techniques implement a reliable online payment through the first data processing request and the second data processing request, two different data processing requests sent by different terminals. Thus, instead of collecting cash by the carrier, the electronic transaction is implemented. It is also safer for the buyer to send the payment to the seller to avoid the conventional scenario that the logistics company needs to send the payment to the seller after it receives the cash from the buyer. The present techniques ensure the collection safety of the seller and that the buyer makes payment after the buyer examines the product.

The present disclosure also provides a server. The server may include one or more processor(s) and memory. The memory is an example of computer-readable media. As used herein, “computer-readable media” includes computer storage media and communication media.

Computer storage media includes volatile and non-volatile, removable and non-removable media implemented in any method or technology for storage of information such as computer-executable instructions, data structures, program modules, or other data. In contrast, communication media may embody computer-readable instructions, data structures, program modules, or other data in a modulated data signal, such as a carrier wave. As defined herein, computer storage media does not include communication media. The memory may store therein program units or modules and program data.

The server may include a receiving unit, an obtaining unit, and a sending unit stored on the memory.

The receiving unit receives the first data processing request initiated by the first communication terminal The first data processing request includes second communication terminal direction information. The obtaining unit obtains the communication code of the second communication terminal according to the second communication terminal direction information. The sending unit sends the request for processing data of the order directed by the second communication terminal direction information according to the communication code.

The receiving unit may further receive the second data processing request initiated by the second communication terminal according to the request for processing data to inform the data processing platform to process data.

To ensure security of the second data processing request, in some examples, the server may further include a generation unit stored on the memory that generates the security verification information corresponding to the communication code of the second communication terminal. The request for processing data includes the security verification information.

Thus, the security verification information is included in the request for processing data and sent to the second communication terminal to verify the buyer. To reduce fraud, the logistics company and the server of the shopping website may exchange a usable or non-usable status of the communication terminal of the carrier of the logistics company and save it in the database of the server. Thus, the database of the server may store communication terminals of each logistics company and a corresponding table of their usable statuses. The corresponding table may include serial number of hardware and its status. Alternatively, the corresponding table may include a code for unique identification of each first communication terminal and its status.

The corresponding table may be stored in the database of the server of the shopping website and the server of the shopping website determines usability of the first communication terminal Alternatively, the corresponding table may be stored and maintained at the database of the server of the corresponding logistics company. The transaction server of the shopping website, after receiving the log-in request of the first communication terminal, forwards the request to the server of the logistics company for identity verification.

Thus, in some examples, the server may further include a verification unit stored on the memory that verifies the validity of the payment code included in the request for processing data. After the payment code is verified to be valid, the obtaining unit of the server obtains the communication code of the second communication terminal according to the second communication terminal direction information.

In the example embodiments, a communication terminal of the carrier initiates a data processing request. Communication code of another communication terminal for payment is obtained according to the second communication terminal direction information included in the data processing request. A request for processing data is sent to the communication terminal of the buyer corresponding to the communication code. The buyer initiates another data processing request according to the request for processing data to request the server to process the payment transaction. Thus, no cash is required in the POD and the electronic online payment is implemented.

The present disclosure also provides an example first communication terminal. The first communication terminal may include one or more processor(s) and memory. The memory is an example of computer-readable media and stores thereon a sending module and a receiving module.

The sending module sends the first data processing request to the server. The first data processing request includes the second communication terminal direction information of a second communication terminal. The receiving module receives the responding message from the server that the data processing platform successfully processes data. The server may perform the following operations.

To prevent fraud, the first communication terminal may also include a log-in module stored on the memory. The log-in module sends the log-in request to the server from the first communication terminal The log-in request includes the security code of the first communication terminal.

The receiving module receives information from the server that the usability of the security code is verified by the server to be usable and generates the payment code of the first communication terminal and saves it.

When the carrier closes the client at the first communication terminal, a log-off request is sent. Thus, the first communication terminal may further include a log-off module stored on the memory to send the log-off request from the first communication terminal to the server. The log-off request includes the payment code so that the serer clears the payment code from the payment code pool.

The above identification verification technique can indirectly identify the identity of the carrier and thus effectively prevent fraud during POD. The techniques that automatically generate the payment code may ensure that the identification of each first communication terminal is periodically checked, which prevents the payment risk arising from static payment code that may last for a long time. In addition, the logistics company may lose control of the first communication terminal such that the first communication terminal is lost. Based on the present techniques, the user cannot initiate any payment action after the dynamic payment code expires, which increases the security of the payment. The first communication terminal may include the PDA, the cell phone, the cell phone with WiFi functionality, and the tablet with WiFi functionality.

The present disclosure also provides an example second communication terminal. The communication terminal may include one or more processor(s) and memory. The memory is an example of computer-readable media and stores thereon a receiving module and a seconding module.

The receiving module receives a request for processing data that is sent by the server after the server receives the first data processing request from the first communication terminal. The first data processing request includes second communication terminal direction information of the second communication terminal. The sending module sends the second data processing request initiated according to the request for processing data to the server.

The receiving module may further receive the responding message from the server that a data processing platform successfully processes data.

As shown in FIG. 1, the present disclosure also provides an example mobile payment system. The system may include the first communication terminal such as the first communication terminal 102(1), the server 104, and the second communication terminal such as the first communication terminal 106(1). The system may further include the data processing platform of the bank system or the third party. The system also involves the telecommunication network or the wireless network related to data transmission and Internet.

The first communication terminal 102(1) sends the first data processing request to the server 104. The first data processing request includes second communication terminal direction information of the second communication terminal. The first communication terminal 102(1) also receives the responding message from the server 104 that the data processing platform successfully processes data.

The server 104 receives the first data processing request initiated by the first communication terminal 102(1). The first data processing request includes second communication terminal direction information. The server 104 obtains the communication code of the second communication terminal 106(1) according to the second communication terminal direction information, sends the request for processing data to the second communication terminal 106(1) according to the communication code, and receives the second data processing request initiated by the second communication terminal 106(1) according to the request for processing data to inform the data processing platform to process data.

The second communication terminal 106(1) receives the request for processing data of the order directed by the second communication terminal direction information, which is sent by the server 104 after the server 104 receives the first data processing request of the first communication terminal 102(1). The second communication terminal 106(1) sends the second data processing request to the server 104 according to the request for processing data, and receives the responding message sent by the server 104 that the data processing platform successfully processes data.

The present techniques implement the electronic POD among the buyer, the carrier, and the shopping website instead of cash transaction. The present techniques implement a reliable online payment through the first data processing request and the second data processing request, two different data processing requests sent by different terminals. Thus, instead of collecting cash by the carrier, the electronic transaction is implemented. It is also safer for the buyer to send the payment to the seller to avoid the conventional scenario that the logistics company needs to send the payment to the seller after it receives the cash from the buyer. The present techniques ensure the collection safety of the seller and that the buyer makes payment after the buyer examines the product.

Those of ordinary skill in the art should understand that each module or step of the present techniques can be realized by hardware, software, or a combination thereof. To illustrate the exchangeability between the hardware and software, the present disclosure generally describes the components and operations in each example embodiment. Whether the functionalities shall be performed by hardware or software depends on the specific application of the present techniques and the constraints. One of ordinary skill in the art may use different methods to implement the described functions for different applications. Such implementation is still within the protection of the present disclosure.

The methods or operations described in the example embodiments may be implemented by hardware, computer-executable instructions performed by one or more processors, or a combination thereof. The units or modules may be stored in the computer storage media. Examples of computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage apparatus, or any other non-transmission medium that can be used to store information for access by a computing apparatus

The present disclosure describes merely example embodiments, which are not intended to limit the present techniques. For those of ordinary skill in the art, the present disclosure may have various variations and alternations. Any modification, equivalent substitution, improvement, and the like, made within the spirit and principle of the present disclosure shall be included in the protection scope of the present techniques.

What is claimed is:

1. A method comprising:
receiving a first data processing request from a first communication terminal, the first data processing request including second communication terminal direction information of a second communication terminal;
obtaining a communication code of the second communication terminal according to the second communication terminal direction information;
sending a request for processing data to the second communication terminal according to the communication code of the second communication terminal; and
receiving a second data processing request from the second communication terminal that is generated according to the request for processing data.

2. The method as recited in claim 1, further comprising informing a data processing platform to conduct processing data.

3. The method as recited in claim 1, further comprising:
after obtaining the communication code of the second communication terminal and prior to sending the request for processing data to the second communication terminal, generating security verification information corresponding to the communication code of the second communication terminal, the request for processing data including the security verification information.

4. The method as recited in claim 3, wherein:
the second data processing request includes the security verification information; and
the receiving the second data processing request from the second communication terminal comprises:
receiving the second data processing request from the second communication terminal;
obtaining the security verification information from the second data processing request;
verifying a validity of the security verification information; and
after verifying that the security verification information is valid, informing a data processing platform to conduct payment processing.

5. The method as recited in claim 1, wherein:
the first data processing request further includes a payment code; and
the method further comprises:
verifying a validity of the payment code included in the first data processing request; and
after verifying that the payment code is valid, obtaining the communication code of the second communication terminal according to the second communication terminal direction information.

6. The method as recited in claim 5, further comprising:
prior to receiving the first data processing request, receiving a log-in request from the first communication terminal, the log-in request including a security code of the first communication terminal;
verifying a usability of the security code;
after verifying that the security code is usable, generating the payment code of the first communication terminal; and sending the payment code to the first communication terminal.

7. The method as recited in claim 1, wherein:
the communication code of the second communication terminal is a cell phone number;
the request for processing data is a message; and
the sending the request for processing data to the second communication terminal according to the communication code of the second communication terminal comprises sending the message to the second communication terminal according to the cell phone number.

8. The method as recited in claim 7, wherein:
the message is a text message; and
the receiving the second data processing request from the second communication terminal comprises receiving a reply message from the second communication terminal corresponding to the text message, the reply message including security verification information or a text including confirming the request for processing data or denying the request for processing data.

9. The method as recited in claim 7, wherein:
the message is a message including a link for processing data; and
the receiving the second data processing request from the second communication terminal comprises receiving a page request for processing data corresponding to the link for processing data, the page request including security verification information.

10. The method as recited in claim 1, wherein:
the communication code of the second communication terminal is a user name of an instant communication tool client;
the request for processing data is a pop-up message; and
the sending the request for processing data to the second communication terminal according to the communication code of the second communication terminal comprises sending the pop-up message to the second communication terminal according to the user name of the instant communication tool client at the second communication terminal, the pop-up message including a link for processing data.

11. The method as recited in claim 10, wherein the receiving the second data processing request from the second communication terminal comprises receiving a page request for processing data corresponding to the link for processing data.

12. A method comprising:
sending, by a first communication terminal, a first data processing request to a server, the first data processing request including second communication terminal direction information of a second communication terminal; and
receiving, by the first communication terminal, a responding message from the server that a data processing platform successfully processes data.

13. The method as recited in claim 12, further comprising:
obtaining, by the server, a communication code of the second communication terminal according to the second communication terminal direction information;
sending, by the server, a request for processing data to the second communication terminal according to the communication code of the second communication terminal; and
receiving, by the server, a second data processing request from the second communication terminal that is generated according to the request for processing data.

14. The method as recited in claim 13, wherein:
the first data processing request includes a payment code; and
the sending, by the first communication terminal, the first data processing request to the server comprises:
sending, by the first communication terminal, a log-in request to the server, the log-in request including a security code of the first communication terminal;
receiving, by the first communication terminal, a payment code generated by the server after the server determines that the security code is valid; and
storing, by the first communication terminal, the payment code.

15. The method as recited in claim 14, further comprising sending, by the first communication terminal, a log-off request to the server, the log-off request including the payment code.

16. The method as recited in claim 15, further comprising clearing, by the server, the payment code from a payment code pool.

17. A system comprising:
a first communication terminal that sends a first data processing request to a server, the first data processing request including second communication terminal direction information of a second communication terminal, and receives a responding message from the server that a data processing platform processes data.

18. The system as recited in claim 17, wherein the server also:
receives the first data processing request from the first communication terminal, the first data processing request includes second communication terminal direction information;
obtains a communication code of the second communication terminal according to the second communication terminal direction information;
sends a request for processing data to the second communication terminal according to the communication code; and
receives a second data processing request from the second communication terminal that is generated according to the request for processing data to inform the data processing platform to process data.

19. The system as recited in claim 17, wherein the second communication terminal also:
sends the request for processing data from the server after the server receives the first data processing request of the first communication terminal;
sends the second data processing request to the server according to the request for processing data; and
receives the responding message sent by the server that the data processing platform successfully processes data.

20. The system as recited in claim 17, wherein the first communication terminal or the second communication terminal is a portable or handheld device.
